(19) United States
(12) Patent Application Publication
(10) Pub. No.: US 2007/0102401 A1
(43) Pub. Date: May 10, 2007

(54) Connector and electronic element thereof

(75) Inventors: Yu-Yuan Tai, Taoyuan Hsien (TW); Ru-Kuen Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/513,280

(22) Filed: Aug. 31, 2006

(30) Foreign Application Priority Data
Nov. 4, 2005 (TW) 94138664

(51) Int. Cl. H01H 33/16

(52) U.S. Cl. 218/143

(57) ABSTRACT

A connector includes at least one electronic element, at least one connection port and a circuit structure. The connection port includes a transmission terminal disposed on one end of the connection port. The electronic element includes a first base and at least one second base, wherein the first base includes at least one first pin, and the second base includes at least one second pin. The second pin is electrically connected to the circuit structure. The first base and the second base define a space for receiving at least one coil, and two ends of the coil are connected to the first pin and the second pin, respectively.

This non-provisional application claims priority under U.S.C. § 119(a) on Patent Application No(s). 094138664 filed in Taiwan, Republic of China on Nov. 04, 2005, the entire contents of which are hereby incorporated by reference.

### BACKGROUND OF THE INVENTION

1. Field of the Invention

The invention relates to connectors and electronic elements thereof, and in particular to a connector and an electronic element with simplified manufacturing process.

2. Description of the Related Art

Recently, various connectors, such as RJ-11, RJ-12 and RJ45 connectors, are utilized in digital and analog signal transmission.

FIG. 1A shows electronic elements disposed in a conventional connector. As shown in FIG. 1A, the connector 10 includes a first circuit board 11 and a second circuit board 12. The first circuit board 11 has several first pins 13 passing through a first substrate 131. The second circuit board 12 has a second pin 14 electrically connected to a pin 15 on a second substrate 141. The pin 15 is electrically connected to a third pin 16.

Several coils 17 are disposed on the first circuit board 11 and the second circuit board 12. The first circuit board 11 and the second circuit board 12 are electrically connected to several transmission terminals 18 which are disposed on the other sides of the first circuit board 11 and the second circuit board 12 opposite to the sides having coils 17.

FIGS. 1B and 1C show assembly of the connector 10. Firstly, as shown in FIG. 1B, the first circuit board 11, one part of the transmission terminals 18 and other corresponding elements are assembled. Then, as shown in FIG. 1C, the second circuit board 12, the other part of the transmission terminals 18 and other corresponding elements are assembled. Finally, the structures in FIGS. 1B and 1C are assembled to achieve the connector 10 in FIG. 1A.

Conventionally, the coils are manually welded to the first circuit board and the second circuit board, which results in complex manufacturing process and wasting time. Also, it is necessary to require two different manufacturing lines for assembling different components. The first circuit board and the second circuit board are separately pre-assembled with transmission terminals, and the connector is then accomplished by assembling these two pre-assembled structures (as shown in FIGS. 1B and 1C). Therefore, the conventional connector is complex to manufacture, and requires great effort. Additionally, the circuit boards are exposed to the air for a long period, such that external particles and moisture adhere thereto easily, and the circuits thereof may be shorted. Further, because the elements of the circuit boards are manually assembled, the elements may be easily dropped or damaged due to carelessness or negligence during the assembling process.

### BRIEF SUMMARY OF THE INVENTION

A detailed description is given in the following embodiments with reference to the accompanying drawings.

The invention provides an electronic element including a first base and at least one second base. The first base includes at least one first pin electrically connected to an external terminal. The second bases include at least one second pin. The first base and the second bases define a space for receiving at least one coil. The two ends of the coils are connected to the first pins and the second pins, respectively. A combination portion is formed on one side of the second base so that the electronic element is connected to another electronic element via the combination portion. The combination portion combines two electronic elements by wedging, abutting, gluing, soldering, contacting or integrally forming.

When the space receives a plurality of coils, the coils are connected in series or parallel in the space. In addition, adhesive, a filler, elastic material or soft material can be filled into the space to seal the coils in the space.

The two ends of the coils are connected to the first pins and the second pins by soldering, clamping or winding. The first base and the second bases include at least one groove for leading and protecting the coils. The number of the grooves is equal to the sum of the first pins and the second pins.

The electronic element further includes a circuit structure welded to the second pins. The circuit structure includes a plurality of openings corresponding to the second pins. The circuit structure is electrically connected to the second pins and an external terminal.

The circuit structure is parallel to the first base and perpendicular to the second bases. The circuit structure can be a printed circuit board (PCB).

The first base and the second bases of the electronic element are made of plastic, metal, alloy, stainless steel or ceramic. The first base and the second bases can be integrally formed as a single piece by injection molding.

The invention further provides a connector including at least one electronic element, at least one connection port and a circuit structure. The connection port includes at least one transmission terminal disposed on an end thereof, and at least one connection pin disposed on another end thereof. The circuit structure is connected to the connection pins, and includes at least one opening corresponding to the second pin. The connector can be a RJ-11, RJ-12 or RJ-45 connector.

The connector and electronic element of the invention are easily assembled. Because the connector can be assembled by using two semi-finished products having the same structure, only one manufacturing line is required to manufacture and assemble the electronic element. Also, during the manufacturing process, the circuit structure is connected to the connection port and then is further connected to the electronic element. As the result, the circuit structure is exposed to the air only for a short period, whereby reducing the opportunity of shorting and damage of the circuit structure. Therefore, the reliability of the final product (connector) is increased. In addition, the design of the grooves of the invention shortens the time for leading the coils. In sum, the connectors and the electronic elements of the invention decrease manufacturing time and cost effectively.

### BRIEF DESCRIPTION OF THE DRAWINGS

The invention can be more fully understood by reading the subsequent detailed description and examples with references made to the accompanying drawings, wherein:

FIG. 1A shows a conventional connector;

FIGS. 1B and 1C show an assembly of the conventional connector;

FIGS. 2A and 2B show an electronic element according to the preferred embodiment of the invention;

FIG. 3A shows a connector according to the preferred embodiment of the invention; and

FIG. 3B and 3C show an assembly of the connector according to the preferred embodiment of the invention.

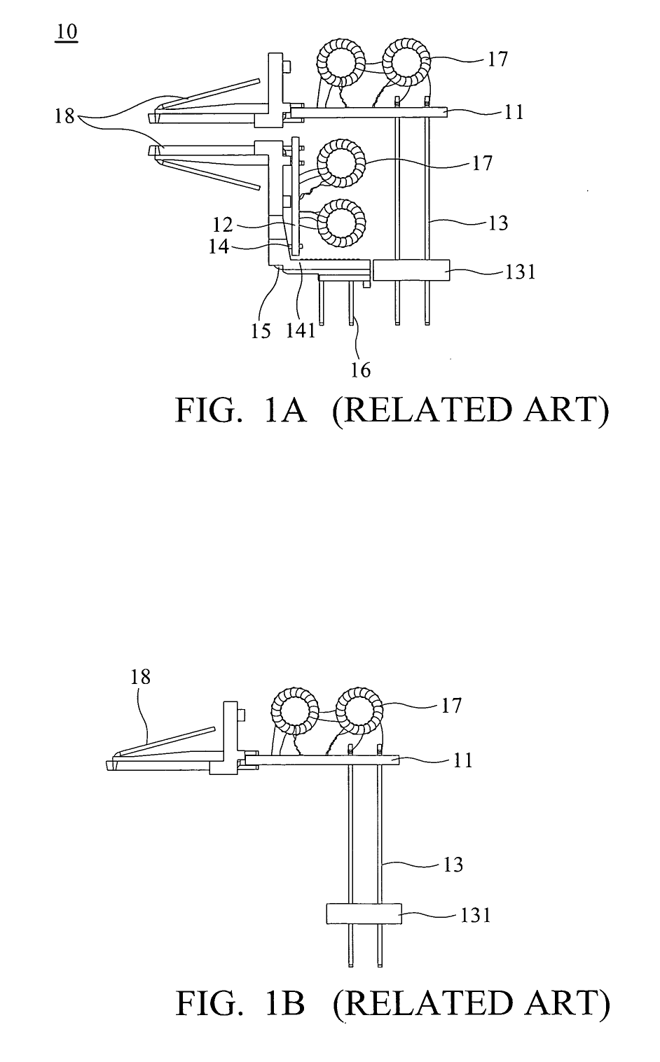

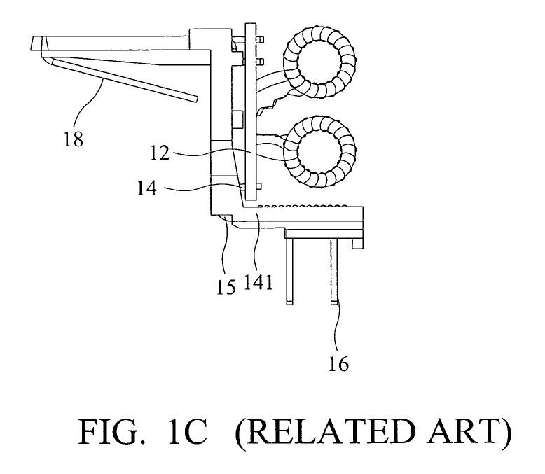

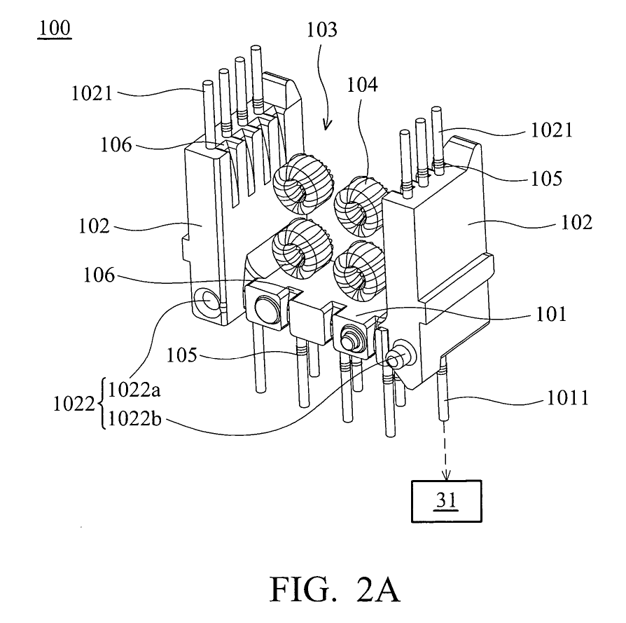

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

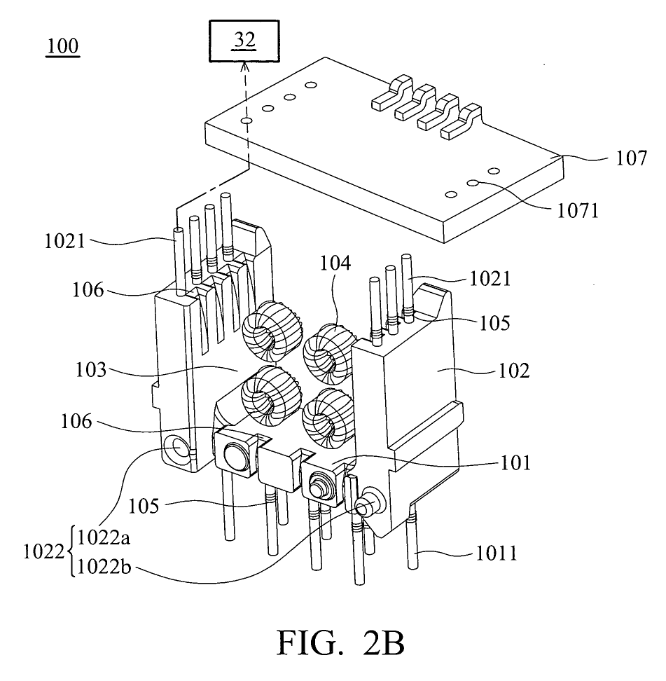

FIG. 2A shows an electronic element 100 according to the preferred embodiment of the invention, and the electronic element 100 includes a first base 101 and at least one second base 102. In this embodiment, the electronic element 100 has one first base 101 and two second bases 102 which are disposed located opposite to each other. The first base 101 includes at least one first pin 1011 electrically connected to an external terminal 31. The second bases 102 include at least one second pin 1021. The first base 101 and the second bases 102 jointly define a space 103 for receiving at least one coil 104, such as four coils 104. Two ends 105 of each coil 104 are connected to the first pin 1011 and the second pin 1021, respectively. A combination portion 1022 is formed on one side of the second base 102 such that the electronic element 100 is connected to another electronic element via the combination portions 1022. As shown in FIG. 2A, the combination portion 1022 includes a recess 1022a and a protrusion 1022b for being connected with the protrusion and the recess of another neighboring electronic element so that the electronic element 100 is connected to the neighboring electronic element via the combination portion 1022. In addition, the combination portions 1022 can combine several electronic elements 100 by wedging, abutting, gluing, soldering, contacting or integrally forming.

When the space 103 receives a plurality of coils 104, the coils 104 are connected in series or in parallel. In addition, adhesive, a filler, elastic material or soft material can be filled into the space 103 to seal the coils 104 in the space 103.

Two ends 105 of the coils 104 are respectively connected to the first pins 1011 and the second pins 1021 by soldering, clamping or winding. Further, the first base 101 and the second bases 102 include at least one groove 106 for leading and protecting the coils 104. The number of the grooves is equal to a sum of the first pins 1011 and the second pins 1021.

As shown in FIG. 2B, the electronic element 100 further includes a circuit structure 107, such as a printed circuit board (PCB), electrically connected to the second pins 1021. The circuit structure 107 includes several openings 1071, and the number and the locations of the openings 1071 are determined corresponding to the second pins 1021. The circuit structure 107 is electrically connected to the second pins 1021 and an external terminal 32.

The circuit structure 107 is parallel to the first base 101 and perpendicular to the second bases 102. The first base 101 and the second bases 102 of the electronic element 100 are made of plastic, metal, alloy, stainless steel or ceramic. The first base 101 or the second bases 102 can be integrally formed as a single piece by injection molding.

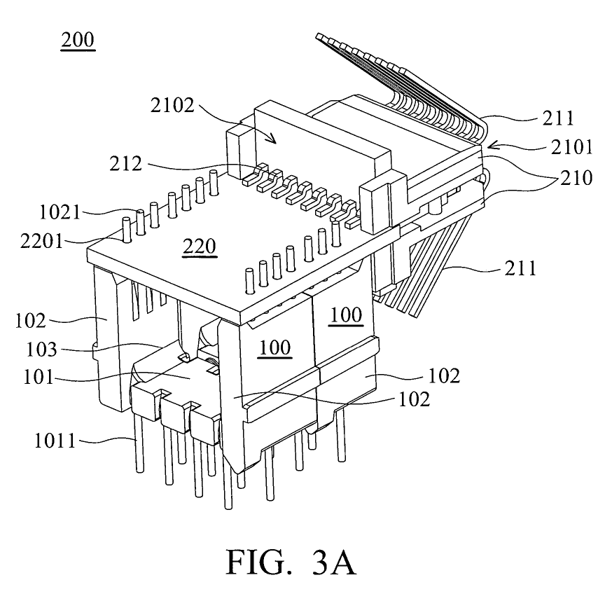

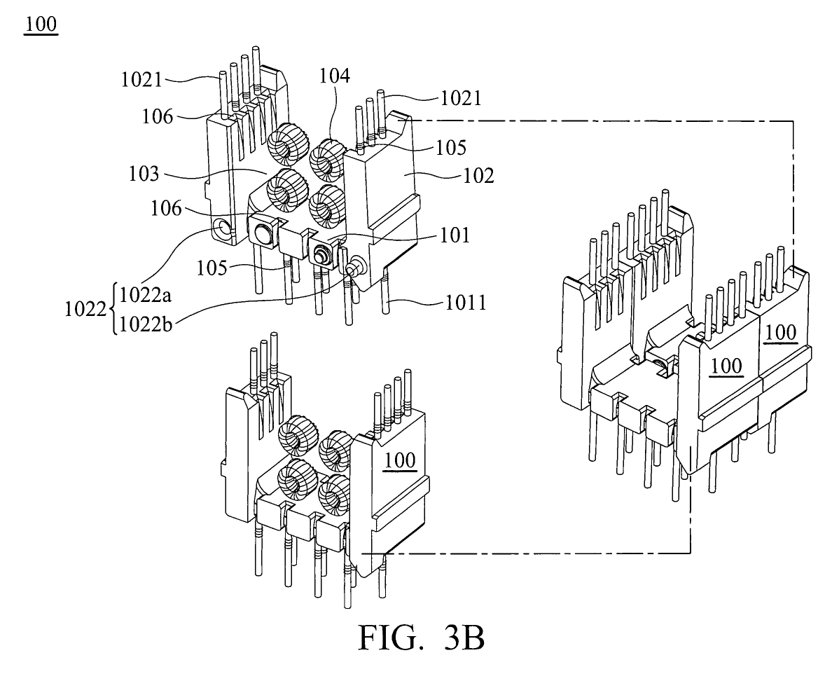

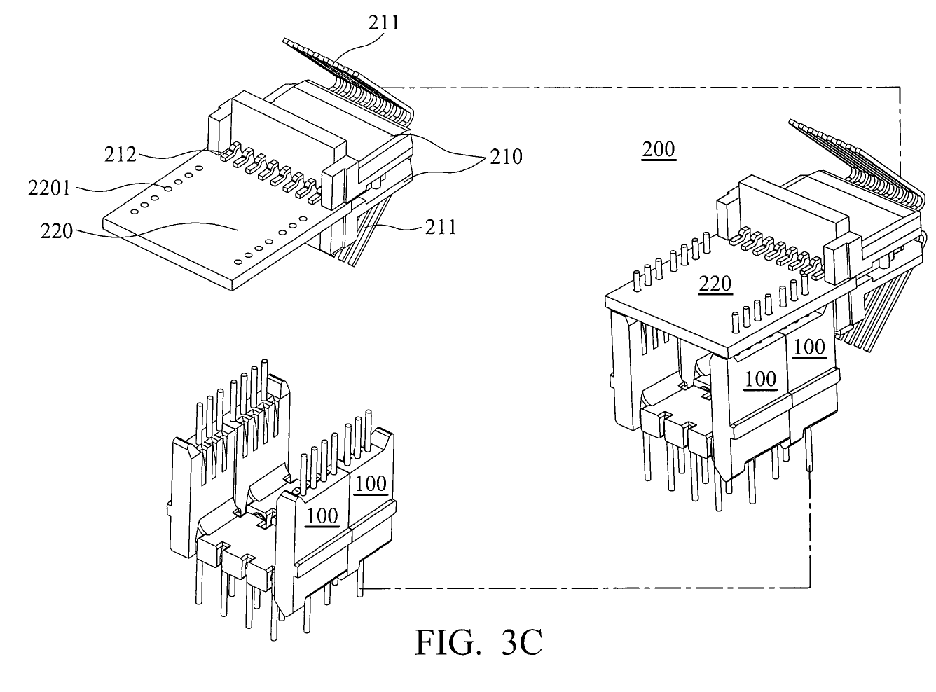

FIG. 3A shows a connector 200 according to the preferred embodiment of the invention, and the connector 200 includes some elements similar to those with same labeled numbers in FIG. 2. The connector 200 includes at least one electronic element 100, at least one connection port 210 and a circuit structure 220. The connection port 210 includes at least one transmission terminal 211 disposed on one edge 2101 of the connection port 210, and at least one connection pin 212 disposed on the other edge 2102 of the connection port 210. The edge 2101 and the other edge 2102 of the connection port 210 are opposite to each other. The circuit structure 202 is connected to the connection pins 212, and the circuit structure 202 includes openings 2201 corresponding to the second pins 1021.

FIGS. 3B and 3C show assembly of the connector 200 according to the preferred embodiment of the invention. As shown in FIG. 3B, two electronic elements 100 are assembled via the connection portion 1022. The connection portion 1022 includes a recess 1022a and a protrusion 1022b. The recess 1022a and the protrusion 1022b abut a recess and a protrusion of another neighboring electronic element 100 corresponding thereto. In addition, the combination portions 1022 can combine several electronic elements 100 by wedging, abutting, gluing, soldering, contacting or integrally forming. Thus, these two electronic elements 100 are arranged side by side. It is noted that the coils at left side of FIG. 3B are not shown at right side of FIG. 3B in order to simplify the description. After these two electronic elements 100 are assembled, the circuit structure 220 and the connection port 210 are assembled with these assembled electronic elements 100 so as to achieve the connector 200, as shown in FIG. 3C. The connector 200 can be a RJ-11, RJ-12 or RJ-45 connector.

The connector and electronic element of the invention are easily assembled. Because the connector can be assembled by using two semi-finished products having the same structure, only one manufacturing line is required to manufacture and assemble the electronic element. Also, during the manufacturing process, the circuit structure is connected to the connection port and then is further connected to the electronic element. As the result, the circuit structure is exposed to the air only for a short period, whereby reducing the opportunity of shorting and damage of the circuit structure. Therefore, the reliability of the final product (connector) is increased. In addition, the design of the grooves of the invention shortens the time for leading the coils. In sum, the connectors and the electronic elements of the invention decrease manufacturing time and cost effectively.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic element, comprising:
a first base, comprising at least one first pin; and
at least one second base, comprising at least one second pin;
wherein the first base and the second base define a space for receiving at least one coil, and two ends of the coil are connected to the first pin and the second pin, respectively.

2. The electronic element as claimed in claim 1, further comprising a circuit structure connected to the second pin, and the circuit structure comprises at least one opening corresponding to the second pin.

3. The electronic element as claimed in claim 2, wherein the circuit structure and the first base are disposed in parallel or in perpendicular.

4. The electronic element as claimed in claim 1, wherein the space receives a plurality of coils and the coils are connected in series or in parallel.

5. The electronic element as claimed in claim 1, wherein an adhesive, a filler, an elastic material or a soft material is filled into the space to seal the coil in the space.

6. The electronic element as claimed in claim 1, wherein the two ends of the coil are connected to the first pin and the second pin by soldering, clamping, or winding.

7. The electronic element as claimed in claim 1, wherein the first base and the second base respectively comprise at least one groove for leading and protecting the coil, and a number of the grooves is equal to a sum of the first pin and the second pin.

8. The electronic element as claimed in claim 1, wherein the first base and the second base comprise plastic, metal, alloy, stainless steel or ceramic.

9. The electronic element as claimed in claim 1, wherein the first base or the second base is integrally formed as a single piece by injection molding.

10. The electronic element as claimed in claim 1, wherein the first pin is electrically connected to an external terminal.

11. The electronic element as claimed in claim 1, wherein the second base comprises a combination portion formed on one side of the second base, and the combination portion comprises a recess and a protrusion.

12. The electronic element as claimed in claim 1, wherein the electronic element is utilized in a connector.

13. A connector, comprising:
at least one electronic element comprising a first base and at least one second base, wherein the first base comprises at least one first pin, the second base comprises at least one second pin, the first base and the second base define a space for receiving at least one coil, and two ends of the coil are connected to the first pin and the second pin, respectively;
at least one connection port, comprising a transmission terminal disposed on one edge of the connection port and a connection pin disposed on the other edge of the connection port; and
a circuit structure connected to the connection pin and comprising at least one opening corresponding to the second pin.

14. The connector as claimed in claim 13, wherein the circuit structure and the the first base are disposed in parallel or in perpendicular.

15. The connector as claimed in claim 13, wherein the space receives a plurality of coils and the coils are connected in series or in parallel.

16. The connector as claimed in claim 13, wherein an adhesive, a filler, an elastic material or a soft material is filled into the space to seal the coil in the space.

17. The connector as claimed in claim 13, wherein the two ends of the coil are connected to the first pin and the second pin by soldering, clamping, or winding.

18. The connector as claimed in claim 13, wherein the first base and the second base respectively comprise at least one groove for leading and protecting the coil, and a number of the grooves is equal to a sum of the first pin and the second pin.

19. The connector as claimed in claim 13, wherein the second base comprises a combination portion formed on one side of the second base so that the electronic element is connected to another electronic element via the combination portion.

20. The connector as claimed in claim 13, wherein the connector is a RJ-11, RJ-12 or RJ-45 connector.
